(19) United States
(12) Patent Application Publication
(10) Pub. No.: US 2025/0328293 A1
(43) Pub. Date: Oct. 23, 2025

(54) ENDURANCE GROUP FOR TIERED STORAGE APPLICATIONS

(71) Applicant: Micron Technology, Inc., Boise, ID (US)

(72) Inventors: John E. Maroney, Irvine, CA (US); Kyle J. Wilkins, Meridian, ID (US); Roy Leonard, San Jose, CA (US); David Alan Holmstrom, Los Gatos, CA (US); Steven Wells, Sacramento, CA (US); Jayashree Bhargava, San Jose, CA (US); Craig Lucero, Loveland, CO (US)

(21) Appl. No.: 19/087,192

(22) Filed: Mar. 21, 2025

Related U.S. Application Data
(60) Provisional application No. 63/635,489, filed on Apr. 17, 2024.

(51) Int. Cl. G06F 3/06

(52) U.S. Cl. CPC G06F 3/0683; G06F 3/0604; G06F 3/0655

(57) ABSTRACT

Methods, systems, and devices for endurance group for tiered storage applications are described. A memory system may implement a single memory device with different types of memory and corresponding data access categories. The memory device may implement endurance groups, which may each include a set of memory cells configurable as single-level cells, triple-level cells, or quad-level cells. The endurance groups may be configured based on a capacity identifier selected for the memory device from a set of capacity identifiers supported by the memory system. Each capacity identifier of the set of capacity identifiers may be associated with a configuration of the endurance groups. The host system may transmit a capacity identifier to indicate a configuration of the memory system. The memory system may support data movement internal to the memory system between the endurance groups, without transferring data between the host system.

### CROSS REFERENCE

The present Application for Patent claims priority to U.S. Patent Application No. 63/635,489 by Maroney et al., entitled “ENDURANCE GROUP FOR TIERED STORAGE APPLICATIONS,” filed Apr. 17, 2024, which is assigned to the assignee hereof, and which is expressly incorporated by reference in its entirety herein.

### TECHNICAL FIELD

The following relates to one or more systems for memory, including endurance group for tiered storage applications.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports endurance group for tiered storage applications in accordance with examples as disclosed herein.

FIG. 2 shows an example of a system that supports endurance group for tiered storage applications in accordance with examples as disclosed herein.

FIG. 3 shows an example of a system that supports endurance group for tiered storage applications in accordance with examples as disclosed herein.

FIG. 4 shows an example of a configuration table that supports endurance group for tiered storage applications in accordance with examples as disclosed herein.

FIG. 5 shows a block diagram of a memory system that supports endurance group for tiered storage applications in accordance with examples as disclosed herein.

FIGS. 6 and 7 show flowcharts illustrating a method or methods that support endurance group for tiered storage applications in accordance with examples as disclosed herein.

### DETAILED DESCRIPTION

Some systems may implement a memory system with a tiered storage approach, in which the memory system may include different types of data storage for different data access categories (e.g., hot, warm, cold). The memory system may include separate memory devices for each type of data storage and corresponding data access category, and each memory device may be represented by a respective namespace. For example, the memory system may include a memory device configured with quad-level cell (QLC) memory to store cold data (e.g., data accessed less frequently), a memory device configured with triple-level cell (TLC) memory to store medium data (e.g., data accessed moderately frequently), and a memory device configured with single-level cell (SLC) memory to store hot data (e.g., data accessed more frequently). However, implementing separate memory devices for each type of data storage and respective data access category may include implementing a controller for each memory device. Implementing multiple memory devices and multiple controllers may increase costs associated with the memory system and may introduce spatial consumption concerns associated with manufacturing the memory system. Likewise, operating the memory system with multiple memory devices may increase overhead (e.g., latency and bandwidth consumption) associated with transferring data between the multiple memory devices. For example, to transfer data from one memory device to another may include transferring the data to a host system, and copying the data from the host system to the receiving memory device. Transferring data via the host system may further exacerbate the overhead associated with data movement.

In accordance with examples as described herein, a memory system may include a single memory device with different types of data storage and corresponding data access categories. The memory device may differentiate between the types of data storage using one or more endurance groups. For example, the memory device may implement endurance groups, which may each include sets of memory cells operable to be configured as SLCs, multi-level cells (MLCs), TLCs, QLCs, or penta-level cells (PLCs) to support the respective data access category. In some cases, the memory device may configure the endurance groups based on a capacity identifier selected for the memory device from a set of capacity identifiers supported by the memory system. Each capacity identifier may be associated with a respective configuration of the endurance groups. For example, the memory device may receive a capacity identifier selection (e.g., from a user or device administrator), and the selected capacity identifier may be mapped to or otherwise associated with a respective set of one or more endurance groups and respective trim settings associated with each endurance group. The trim settings may include a quantity of endurance groups, a size of each endurance group (e.g., a quantity of SLCs, MLCs, TLCs, QLCs, or PLCs associated with the endurance group), target bandwidths of each endurance group, or other operating parameters (e.g., logical address allocation, logical address deallocation). For example, if a first capacity identifier is selected for a memory device, the memory device may be configured with a first endurance group including a set of SLCs and a second endurance group including a set of TLCs, where the memory device may include an equal quantity of SLCs and TLCs. The selected capacity identifier and corresponding configurations of memory storage within a memory device may be based on one or more parameters associated with the memory system, such as a demand of the memory system. Accordingly, implementing a single memory device that includes the types of data storage and data access categories based on a demand of the memory system may decrease costs and spatial concerns otherwise associated with implementing multiple memory devices.

In some cases, each endurance group may include one or more namespaces. A namespace may be a range of logical addresses addressable by a particular application, addressable by a particular host system, and/or addressable to use with a particular category of data. In some such cases, a host system may identify and access the namespaces associated with the memory device based on data access categories associated with the namespaces. For example, a namespace of an endurance group configured to include QLC memory may be associated with accessing cold data, whereas a namespace of another endurance group configured to include SLC memory may be associated with accessing hot data. Due to the single memory device including one or more namespaces, the memory device may transfer data internally between the endurance groups (e.g., based on signaling or other indications from the host system) without transferring the data to and from the host system. Accordingly, operating the single memory device including multiple types of data storage may decrease overhead (e.g., latency and bandwidth consumption) otherwise associated with transferring data between multiple memory devices. Likewise, performing data movement internal to the memory device may further decrease overhead otherwise associated with implementing the host system for facilitating data movement.

In addition to applicability in memory systems as described herein, techniques for endurance group for tiered storage applications may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by implementing multiple types of memory in a single memory device, which may enable data movement between different memory types within the single memory device (e.g., rather than between multiple memory devices each implementing a single type of memory), thereby decreasing processing or latency times, improving response times, or otherwise improving user experience, among other benefits.

In addition to applicability in memory systems described herein, techniques for endurance group for tiered storage applications may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by implementing multiple types of memory in a single memory device, which may enable data movement between different memory types within the single memory device (e.g., rather than between multiple memory devices each implementing a single type of memory), thereby decreasing unauthorized access to data during external signaling (e.g., memory system-to-host system, host system-to-memory system).

In addition to applicability in memory systems as described herein, techniques for endurance group for tiered storage applications may be generally implemented to improve the sustainability of various electronic devices and systems. As the use of electronic devices has become even more widespread, the quantity of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by implementing multiple types of memory in a single memory device, which may enable a single controller for the multiple types of memory (e.g., rather than a controller for each type of memory), thereby resulting in decreased spatial concerns, greater yield, and reduced manufacturing cost, among other benefits.

Features of the disclosure are illustrated and described in the context of systems, devices, and circuits. Features of the disclosure are further illustrated and described in the context of systems, tables, and flowcharts.

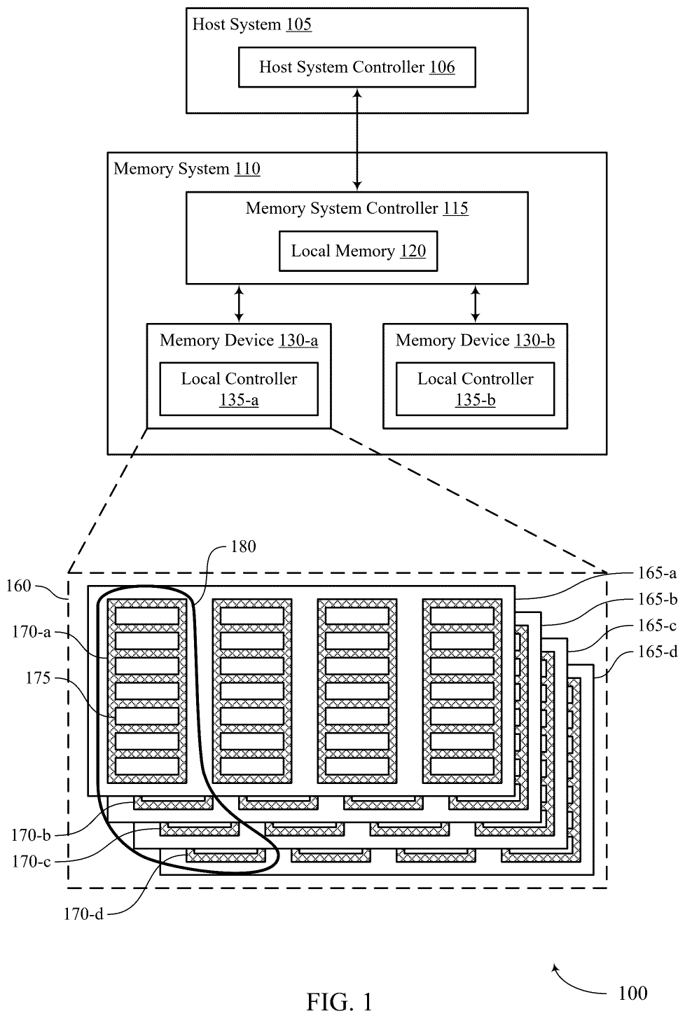

FIG. 1 shows an example of a system 100 that supports endurance group for tiered storage applications in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support endurance group for tiered storage applications. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In accordance with examples as described herein, the memory system 110 may include a single memory device 130 with different types of data storage and corresponding data access categories. The memory device 130 may differentiate between the types of data storage using one or more endurance groups. For example, the memory device 130 may implement endurance groups, which may each include sets of memory cells operable to be configured as SLCs, TLCs, or QLCs, to support the respective data access category. In some cases, the memory device 130 may configure the endurance groups based on a capacity identifier selected for the memory device 130 from a set of capacity identifiers supported by the memory system 110. Each capacity identifier may be associated with a respective configuration of the endurance groups. For example, the memory device 130 may receive a capacity identifier selection (e.g., from a user or device administrator), and the selected capacity identifier may be mapped to or otherwise associated with a respective set of one or more endurance groups and respective trim settings associated with each endurance group. The trim settings may include a quantity of endurance groups, a size of each endurance group (e.g., a quantity of SLCs, TLCs, or QLCs associated with the endurance group), target bandwidths of each endurance group, or other operating parameters (e.g., logical address allocation, logical address deallocation). For example, if a first capacity identifier is selected for the memory device 130, the memory device 130 may be configured with a first endurance group including a set of SLCs and a second endurance group including a set of TLCs, where the memory device 130 may include an equal quantity of SLCs and TLCs. The selected capacity identifier and corresponding configurations of memory storage within a memory device 130 may be based on one or more parameters associated with the memory system 110, such as a demand of the memory system 110. Accordingly, implementing a single memory device 130 that includes the types of data storage and data access categories based on a demand of the memory system 110 may decrease costs and spatial concerns otherwise associated with implementing multiple memory devices 130.

In some cases, each endurance group may include one or more namespaces. A namespace may be a range of logical addresses that include memory cells of the respective endurance group. Memory cells within a namespace may be addressable by a particular application, addressable by a particular host system, and/or addressable to use with a particular category of data, among other examples. In some such cases, the host system 105 may identify and access the namespaces associated with the memory device 130 based on data access categories associated with the namespaces. For example, a namespace of an endurance group configured to include QLC memory may be associated with accessing cold data, whereas a namespace of another endurance group configured to include SLC memory may be associated with accessing hot data. Due to the single memory device 130 including one or more namespaces, the memory device 130 may transfer data internally between the endurance groups (e.g., based on signaling or other indications from the host system) without transferring the data to and from the host system 105. Accordingly, operating the single memory device 130 including multiple types of data storage may decrease overhead (e.g., latency and bandwidth consumption) otherwise associated with transferring data between multiple memory devices 130. Likewise, performing data movement internal to the memory device 130 may further decrease overhead otherwise associated with implementing the host system 105 for facilitating data movement.

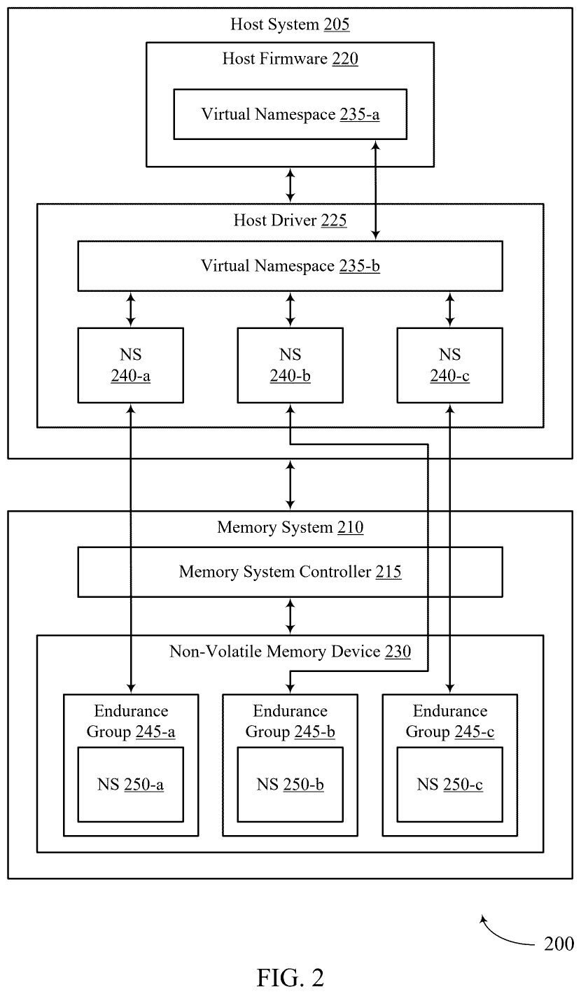

FIG. 2 shows an example of a system 200 that supports endurance group for tiered storage applications in accordance with examples as disclosed herein. The system 200 may illustrate aspects or operations of a system, which may be an example of a system 100, as described with reference to FIG. 1. For example, the system 200 may include a host system 205 and a memory system 210, which may be examples of a host system 105 and a memory system 110, respectively, as described with reference to FIG. 1. The memory system 210 may include a non-volatile memory device 230 configured to include different types of memory corresponding to different data access categories.

The memory system 210 may include a memory system controller 215, which may be an example of a memory system controller 115, as described with reference to FIG. 1. The memory system controller 215 may be configured to facilitate operations in accordance with commands received from the host system 205. For example, the memory system controller 215 may be configured to perform access and memory management operations (e.g., maintenance operations) on the non-volatile memory device 230, which may be an example of a memory device 130, as described with reference to FIG. 1. In some cases, the non-volatile memory device 230 may be coupled with the memory system controller 215, such that the memory system controller 215 may function as a local controller for the memory system controller 215. The non-volatile memory device 230 may be a memory die including a non-volatile memory array (e.g., a NAND memory array) of non-volatile memory cells (e.g., NAND memory cells).

The non-volatile memory device 230 may be configured (e.g., via a capacity identifier) to include a quantity of endurance groups 245, which may each include a set of memory cells (e.g., non-volatile memory cells) of the non-volatile memory array. For example, as illustrated in FIG. 2, the non-volatile memory device 230 may include three endurance groups 245 (e.g., an endurance group 245-a, an endurance group 245-b, an endurance group 245-c). The non-volatile memory device 230 may be configured with a capacity identifier, and each endurance group 245 may be associated with a respective set of trim settings based on the capacity identifier. Accordingly, each endurance group 245 may support a respective type of memory (e.g., a quantity of each type of memory) in accordance with the respective set of trim settings. For example, each endurance group 245 may include memory cells configured to operate according to a type of memory (e.g., a quantity of levels). That is, each endurance group 245 may include single-level cells (e.g., each configured to store one bit of information), multi-level cells (e.g., each configured to store two bits of information), triple-level cells (e.g., each configured to store three bits of information), quad-level cells (e.g., each configured to store four bits of information), or multiple-level cells (e.g., each configured to store a quantity (>4) of bits of information, such as penta-level cells). For example, the endurance group 245-a may be configured to support QLC memory, the endurance group 245-b may be configured to support TLC memory, and the endurance group 245-c may be configured to support SLC memory. In some cases, each endurance group 245 may be configured to include a quantity of memory cells. For example, each endurance group 245 may be configured to include a quantity of SLCs, TLCs, or QLCs.

Further, each endurance group 245 may be associated with one or more namespaces 250 (e.g., a namespace 250-a, a namespace 250-b, a namespace 250-c). A namespace 250 may include a range of addresses that identify a corresponding quantity of memory cells included in the namespace 250. The namespace 250 may be addressable by a particular application, addressable by a particular host system, and/or addressable to use with a particular category of data. For example, each endurance group 245 may include one or more namespaces 250 corresponding to the set of memory cells of the endurance group 245. In some cases, the namespaces 250 may be associated with the endurance groups 245 based on configuring the endurance groups 245.

In some cases, each endurance group 245 may be associated with a data access category. For example, the endurance group 245-a storing “cold” data may store data that is accessed relatively less frequently, whereas the endurance group 245-b storing “medium” data (e.g., “warm” data) may store data that is accessed moderately frequently, and the endurance group 245-c storing “hot” data may store data that is access relatively more frequently.

In some such cases, each endurance group 245 may be associated with a data access category based on the type of memory configured at the respective endurance group 245. For example, the endurance group 245-c configured to implement SLC memory may be associated with storing hot data (e.g., due to SLC memory being accessed with relatively lower latency), whereas the endurance group 245-b configured to implement TLC memory may be associated with storing medium data (e.g., due to TLC memory being accessed with moderate latency), and the endurance group 245-a configured to implement QLC memory may be associated with storing cold data (e.g., due to QLC memory being accessed with relatively higher latency). In some cases, the namespaces 250 of the endurance groups 245 may be associated with a data access category based on the data access category of the endurance group 245. That is, the namespace 250-a may be associated with storing cold data based on the endurance group 245-a implementing QLC memory, the namespace 250-b may be associated with storing medium data based on the endurance group 245-b implementing TLC memory, and the namespace 250-c may be associated with storing hot data based on the endurance group 245-c implementing SLC memory.

The host system 205 may include host firmware 220 and a host driver 225. The host firmware 220 may include an operating system, such that the host firmware 220 may be implemented in a host system controller, such as a host system controller 106, as described with reference to FIG. 1. The host firmware 220 may include a virtual namespace 235-a which may include indications of the namespaces 250 associated with the endurance groups 245. That is, the virtual namespace 235-a may include a copy of a total range of addresses including each range of addresses associated with the namespaces 250. In some cases, the virtual namespace 235-a may also include a range of addresses associated with memory internal to the host system 205.

The host driver 225 may include hardware and firmware associated with operating the memory system 210. In some cases, the host driver 225 may be a caching driver configured to operate as a memory for the host system 205. The host driver 225 may include a virtual namespace 235-b, which may be a copy of the virtual namespace 235-a. The virtual namespace 235-b may include indications of the namespaces 250, such that the virtual namespace 235-b may include an indication 240-a of the namespace 250-a associated with the endurance group 245-a, an indication 240-b of the namespace 250-b associated with the endurance group 245-b, and an indication 240-c of the namespace 250-c associated with the endurance group 245-c. In some cases, the host system 205 (e.g., the host firmware 220 or the host driver 225, or both) may store indications of the endurance groups 245, such that the host system 205 may support identifying the endurance groups 245 from the non-volatile memory device 230.

The system 200 may support movement of data between the endurance groups 245 within the non-volatile memory device 230. That is, the memory system 210 may be configured to support transferring data internally within the non-volatile memory device 230. For example, the memory system controller 215 may be configured to facilitate transferring the data from the endurance group 245-c to the endurance group 245-b. Moving data between the endurance groups 245 may include transferring (e.g., copying) the data between the namespaces 250 associated with the respective endurance groups 245. For example, transferring the data from the endurance group 245-c to the endurance group 245-b may include transferring the data from the namespace 250-c to the namespace 250-b. In some cases, transferring the data between the namespaces 250 may include transferring the data from a range of addresses associated with the initial namespace 250 to the range of addresses associated with the receiving namespace 250, such that the data may be transferred from a set of memory cells associated with the initial namespace 250 to another set of memory cells associated with the receiving namespace 250.

In some cases, the memory system 210 may transfer data internally within the non-volatile memory device 230 without transferring the data to the host system 205. In some cases, the memory system 210 may transfer data internally within the non-volatile memory device 230 based on receiving signaling from the host system 205. For example, the movement of data within the non-volatile memory device 230 may be triggered based on receiving a command to perform a memory management operation or a maintenance operation. In other examples, the movement of data within the non-volatile memory device 230 may be triggered based on satisfying a duration or a threshold quantity of access operations since performing a memory management operation or a maintenance operation. In some cases, the memory system 210 may not support performing some maintenance procedures across the endurance groups 245 of the non-volatile memory device 230. For example, the memory system 210 may not support performing garbage collection on an endurance group 245 while concurrently performing garbage collection on another endurance group 245. Likewise, the memory system 210 may not support consolidating valid data from multiple endurance groups 245 within a single endurance group 245 as a result of performing a garbage collection operation.

In some cases, the memory system 210 may be configured to transfer data between the endurance groups 245 based on the data access categories associated with the endurance groups 245. That is, because the endurance group 245-b is associated with TLC memory, and the endurance group 245-c is associated with SLC memory, and TLC memory is associated with storing medium data, whereas SLC memory is associated with storing hot data; the memory system 210 may transfer medium data identified in the endurance group 245-c to the endurance group 245-b, and the memory system 210 may transfer hot data identified in the endurance group 245-b to the endurance group 245-c. Likewise, because the endurance group 245-a is associated with QLC memory and QLC memory is associated with storing cold data, the memory system 210 may transfer cold data identified in the endurance group 245-b to the endurance group 245-a, and the memory system may transfer medium data identified in the endurance group 245-a to the endurance group 245-b.

Implementing the endurance groups 245 within the non-volatile memory device 230 may enable internal data movement without transferring data to the host system 205. Thus, implementing the endurance groups 245 may prevent unnecessary overhead (e.g., latency, bandwidth consumption) otherwise associated with data movement. Likewise, implementing the endurance groups 245 within the non-volatile memory device 230 may enable a single controller for operating multiple types of memory, thereby supporting reduced spatial consumption otherwise associated with implementing multiple controllers (e.g., for each type of memory) within the memory system 210. Further, implementing the endurance groups 245 supporting individual configuration may enable different proportions of the types of memory based on demands of the memory system 210 (e.g., different data access categories). Thus, the memory system 210 may support more data assignment flexibility based on implementing the endurance groups 245 within the non-volatile memory device 230.

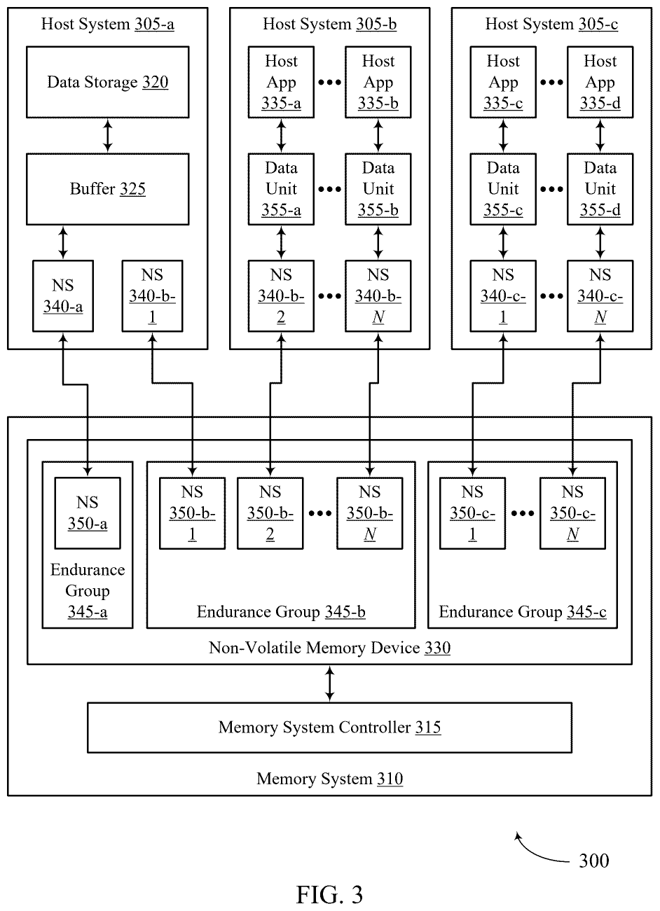

FIG. 3 shows an example of a system 300 that supports endurance group for tiered storage applications in accordance with examples as disclosed herein. The system 300 may illustrate aspects or operations of a system, which may be an example of a system 100 or a system 200, as described with reference to FIGS. 1 and 2, respectively. For example, the system 300 may include host systems 305 (e.g., a host system 305-a, a host system 305-b, a host system 305-c) and a memory system 310, which may be examples of a host system 205 and a memory system 210, respectively, as described with reference to FIG. 2. The memory system 310 may include a non-volatile memory device 330 configured to include different types of memory corresponding to different data access categories.

The system 300 may include the host system 305-a, the host system 305-b, the host system 305-c, or any combination thereof coupled with the memory system 310. In some examples, such as scenarios in which the system 300 is used for an automotive use case, the system 300 may include the host system 305-a coupled with the memory system 310 and may not include the host systems 305-b and 305-c. In some other examples, such as scenarios in which the system 300 is used for data center use cases, the system 300 may include the host system 305-b and the host system 305-c and may not include the host system 305-a. In automotive use cases, the host system 305-a may be a host black box application. For example, the host system 305-a may be implemented within a vehicle and configured to couple with the memory system 310 implemented at the vehicle. However, in some examples, the host system 305-a may be separate from the vehicle (e.g., at a control center) and configured to communicate with the memory system 310 implemented at the vehicle. In other examples, the host system 305-a may be implemented within the vehicle and configured to communicate with the memory system 310 separate from the vehicle (e.g., at the control center). In data center use cases, the host systems 305-b and 305-c may be a host applications. For example, the host systems 305-b and/or 305-c may be implemented within a data center and configured to communicate with the memory system 310 implemented at the user device. However, in some examples, the host systems 305-b and/or 305-c may be implemented at the user device and configured to couple with the memory system 310 implemented at the user device. In other examples, the host systems 305-b and/or 305-c may be implemented at the user device and configured to communicate with the memory system 310 implemented at the data center.

The memory system 310 may implement aspects of the memory system 210. For example, the memory system 310 may include a memory system controller 315, which may be an example of a memory system controller 215, the non-volatile memory device 330, which may be an example of a non-volatile memory device 230, one or more endurance groups 345, which may be examples of endurance groups 245, and one or more namespaces 350 associated with the endurance groups 345, which may be examples of namespaces 250, as described with reference to FIG. 2. However, the memory system 310 as shown in FIG. 3 includes more than one namespace 350 per endurance group 345. For example, the endurance group 345-b includes a quantity of namespaces 350-b (e.g., namespaces 350-b-1 to 350-b-N) and the endurance group 345-c includes a quantity of namespaces 350-c (e.g., namespaces 350-c-1 to 350-c-N). The endurance group 345-a may be associated with SLC memory, the endurance group 345-b may be associated with TLC memory or QLC memory, and the endurance group 345-c may be associated with SLC memory, in some examples. In other examples, the endurance groups 345 may also be associated with MLC memory or PLC memory, or another type of memory corresponding to each cell being configured to store multiple bits of information.

The host system 305-a may include a data storage 320 configured to store video and sensor data associated with the vehicle. In some cases, the data storage 320 may be configured to store up to one gigabyte of data and may perform data compression on the data. The host system 305-a may additionally, or alternatively, include a cyclic buffer 325 configured to buffer data between the data storage 320 and namespaces 340 of the host system 305-a. That is, the host system 305-a may include the namespaces 340, which may correspond to indications of the namespaces 350 associated with the endurance groups 345. For example, the host system 305-a may include a namespace 340-a corresponding to an indication of the namespace 350-a, and a namespace 340-b-1 corresponding to an indication of the namespace 350-b-1.

The host systems 305-b and 305-c may include one or more host applications 335. For example, the host system 305-b may include a quantity of host applications 335-a to 335-b, and the host system 305-c may include a quantity of host applications 335-c to 335-d. The host applications 335 may be operable to function as the firmware or operating system of the host systems 305-b and 305-c. The host systems 305-b and 305-c may additionally, or alternatively, include data units 355 configured to store data associated with the host systems 305-b and 305-c, respectively. For example, the host system 305-b may include a quantity of data units 355-a to 355-b, and the host system 305-c may include a quantity of data units 355-c to 355-d. The data units 355-a and 355-b may be configured as medium frequency databases (e.g., configured to store data accessed relatively frequently), artificial intelligence (AI) metadata storages, or mapping data storages. Likewise, the data units 355-c and 355-d may be configured as relatively high frequency databases (e.g., configured to store data accessed more frequently), logging data storages, or critical data storages. The host systems 305-b and 305-c may include namespaces 340, which may correspond to indications of the namespaces 350 associated with the endurance groups 345. For example, the host system 305-b may include a namespace 340-b-2 corresponding to an indication of the namespace 350-b-2, and a namespace 340-b-N corresponding to an indication of the namespace 350-b-N (e.g., where N is indicative of a quantity of namespaces 350 in a given endurance group 345).

Implementing the endurance groups 345 may enable internal data movement within the non-volatile memory device 330 without transferring data to the host systems 305-a, 305-b, and 305-c, thereby reducing unnecessary overhead (e.g., latency, bandwidth consumption) otherwise associated with data movement. Thus, the memory system 310 may support more data assignment flexibility based on implementing the endurance groups 345 within the non-volatile memory device 330.

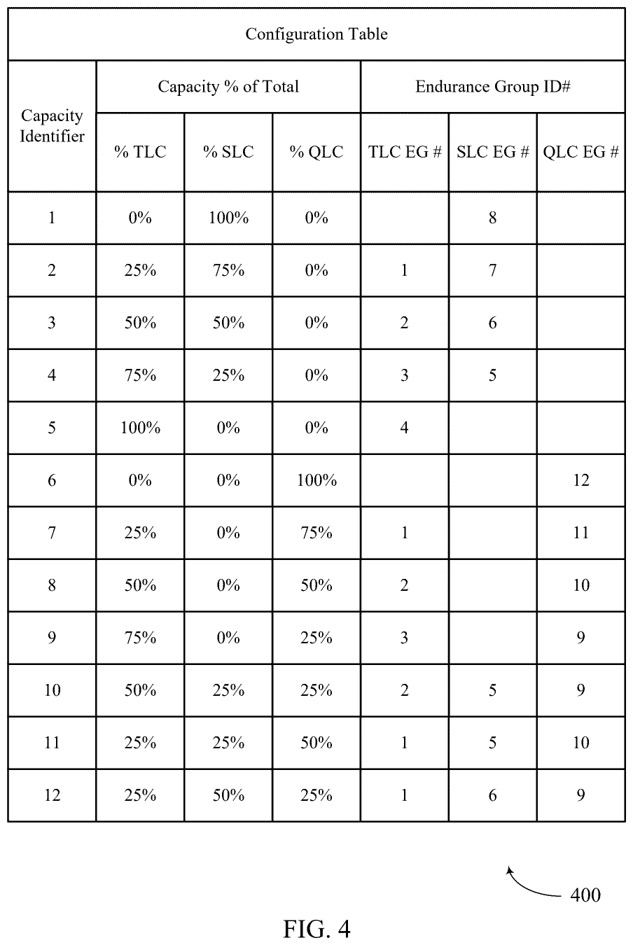

FIG. 4 shows an example of a configuration table 400 that supports endurance group for tiered storage applications in accordance with examples as disclosed herein. The configuration table 400 may illustrate operations or configurations of a system, which may be an example of a system 200 or a system 300, as described with reference to FIGS. 2 and 3, respectively. For example, the configuration table 400 illustrates an example set of configurations for a non-volatile memory device 230 of the system 200.

The configuration table 400 includes a set of capacity identifiers, each associated with a configuration of the non-volatile memory device 230. For example, the configuration table 400 includes 12 capacity identifiers associated with 12 configurations that the non-volatile memory device 230 may support. The configuration table 400 should be understood as being exemplifying rather than limiting. In some examples, additional configurations not illustrated in the configuration table 400 may be supported by the memory device 230, or configurations illustrated in the configuration table 400 may not be supported by the memory device 230, or any combination thereof.

Each capacity identifier may indicate configurations of endurance groups 245 of the non-volatile memory device 230. That is, each capacity identifier may indicate a corresponding set of one or more endurance groups 245, and each endurance group 245 may be associated with a respective set of trim settings for configuring each endurance group 245 of the non-volatile memory device 230. For example, the capacity identifier may indicate a quantity and type of endurance groups 245 to implement at the non-volatile memory device 230, and accordingly, a quantity (e.g., percentage) of each type of memory cells to implement at the non-volatile memory device 230. That is, each capacity identifier may correspond to configuring a quantity of endurance groups 245 with SLC memory, a quantity of endurance groups 245 with TLC memory, and a quantity of endurance groups 245 with QLC memory, or any combination thereof. In some cases, the endurance groups 245 may each be associated with trim settings. For example, each endurance group 245 may be associated with trim settings such as target bandwidths or other operating parameters (e.g., logical address allocation, logical address deallocation). Thus, each capacity identifier may indicate a unique combination of endurance group 245 configurations, and may thereby implement trim settings at each endurance group 245, such that each capacity identifier may indicate a quantity and type of memory cells to implement at a quantity of endurance groups 245.

Accordingly, the configuration table 400 includes a column that indicates a capacity percentage of total for each type of memory. This column may indicate what percentage of a total quantity of memory cells of the non-volatile memory device 230 should be configured as each respective type of memory. For example, the configuration table 400 illustrates a capacity percentage for TLC memory (e.g., indicating the percentage of the total quantity of memory cells that are configured as TLCs), a capacity percentage for SLC memory (e.g., indicating the percentage of the total quantity of memory cells that are configured as SLCs), and a capacity percentage for QLC memory (e.g., indicating the percentage of the total quantity of memory cells that are configured as QLCs). Each capacity identifier may be associated with a capacity percentage of TLC memory, a capacity percentage of SLC memory, and a capacity percentage of QLC memory. Although not illustrated in the configuration table 400, the configuration table 400 may support a capacity percentage for MLC memory, PLC memory, or other types of memory for which the cells thereof are configured to store multiple bits of information. For example, a capacity identifier “1” may be associated with the non-volatile memory device 230 having 100% of the memory cells configured to operate as SLCs. Likewise, a capacity identifier “2” may be associated with the non-volatile memory device 230 having 25% of the memory cells configured to operate as TLCs and 75% of the memory cells configured to operate as SLCs.

Further, the configuration table 400 may include endurance group identifiers that are each associated with a respective quantity and type of endurance groups 245. That is, for each type of endurance group, the configuration table 400 may include a subset of endurance group identifiers, each indicating a percentage of the total memory that the respective endurance group 245 is configured to occupy. For example, an TLC endurance group may be associated with endurance group identifiers “1-4”, a SLC endurance group may be associated with endurance group identifiers “5-8”, and a QLC endurance group may be associated with endurance group identifiers 9-12.” In some implementations, because each type of endurance group may be associated with four endurance group identifiers, each endurance group identifier of the subset of endurance group identifier for that type of endurance group may be associated with a respective percentage (e.g., 25%, 50%, 75%, 100%). For example, endurance group identifier “1”, endurance group identifier “5”, and endurance group identifier “9” may be associated with the TLC endurance group, the SLC endurance group, and the QLC endurance group each occupying 25% of the total memory. However, any of endurance group identifier “4”, endurance group identifier “8”, and endurance group identifier “12” may be associated with any of the TLC endurance group, the SLC endurance group, or the QLC endurance group occupying 100% of the total memory.

Each capacity identifier may be associated with one or more endurance group identifiers. For example, the capacity identifier “1” may be associated with the endurance group identifier “8”, which configures the SLC endurance group to occupy 100% of the total memory. Likewise, the capacity identifier “2” may be associated with the endurance group identifier “1” and “7”, which configures the TLC endurance group to occupy 25% of the total memory and the SLC endurance group to occupy 75% of the total memory. That is, when the capacity identifier is selected, the non-volatile memory device 230 can identify, from the configuration table 400, the capacity percentages, which may then be mapped to the respective endurance group identifiers accordingly. Each endurance group identifier is associated with a single respective endurance group 245. In some cases, each endurance group identifier may also indicate trim settings associated with operating the endurance groups 245. For example, the endurance group identifiers may specify latencies for operating each endurance group 245. In some implementations, the latencies may be programming (e.g., write) latencies or read latencies.

The system 200 may configure the non-volatile memory device 230 based on the capacity identifiers. In some cases, the configuration table 400 may be stored at the host system 205 (e.g., within the host firmware 220 or the host driver 225). In some such cases, the host system 205 may identify a capacity identifier based on an intended use for the non-volatile memory device 230 (e.g., based on a data access category of an upcoming access command). In some examples, identifying the capacity identifier may include accessing the configuration table 400 stored at the host system 205. The host system 205 may transmit an indication of the capacity identifier to the memory system 210 for configuring the non-volatile memory device 230. For example, the host system 205 may identify hot data associated with a write command and may transmit an indication of the capacity identifier “1”, which may correspond to configuring the non-volatile memory device 230 with SLC memory, based on SLC memory being most appropriate for storing the hot data. In some cases, the memory system controller 215 may receive the capacity identifier from the host system 205, and the memory system controller 215 may configure the non-volatile memory device 230 based on receiving the capacity identifier. In some cases, the host system 205 may select the capacity identifier from the configuration table 400 based on receiving input from a user. For example, the host system 205 may receive an indication from a user (e.g., via a user interface) of the system 200 for configuring the non-volatile memory device 230, and the host system 205 may select the capacity identifier based on receiving the indication. In other examples, the user may access the configuration table 400 and select the capacity identifier, then transmit an indication of the selected capacity identifier to the host system 205, which may facilitate configuring the non-volatile memory device 230.

Implementing the configuration table 400 may support configuring the non-volatile memory device 230, which may offer improved flexibility for data assignment and the system 200. For example, implementing the configuration table 400 may enable the host system 205 to configure the non-volatile memory device 230, thereby allowing the memory system 210 to be configured for a desired access operation. Likewise, the configuration table 400 may support user defined configurations, which may be set and later selected for use in configuring the non-volatile memory device 230. Further, implementing the endurance groups 245, which may be configured by utilizing the configuration table 400 may prevent unnecessary overhead (e.g., latency, bandwidth consumption) otherwise associated with data movement. Likewise, implementing the configuration table 400 may enable a single controller for operating multiple types of memory, thereby supporting reduced spatial consumption otherwise associated with implementing multiple controllers (e.g., for each type of memory) within the memory system 210.

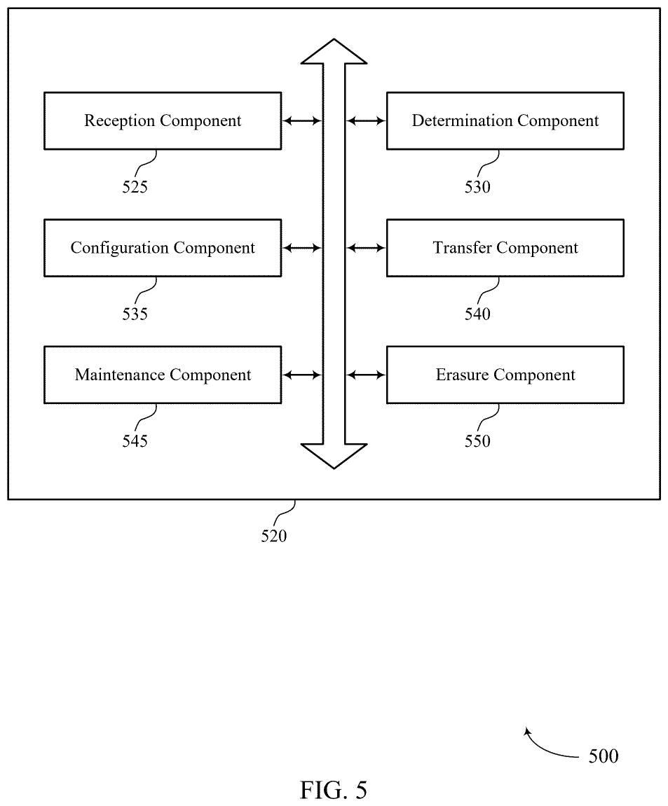

FIG. 5 shows a block diagram 500 of a memory system 520 that supports endurance group for tiered storage applications in accordance with examples as disclosed herein. The memory system 520 may be an example of aspects of a memory system as described with reference to FIGS. 1 through 4. The memory system 520, or various components thereof, may be an example of means for performing various aspects of endurance group for tiered storage applications as described herein. For example, the memory system 520 may include a reception component 525, a determination component 530, a configuration component 535, a transfer component 540, a maintenance component 545, an erasure component 550, or any combination thereof. Each of these components, or components of subcomponents thereof (e.g., one or more processors, one or more memories), may communicate, directly or indirectly, with one another (e.g., via one or more buses).

The reception component 525 may be configured as or otherwise support a means for receiving an indication of a capacity identifier for a memory array in the memory system. The determination component 530 may be configured as or otherwise support a means for determining, based at least in part on the capacity identifier, an endurance group for a set of memory cells in the memory array, where the endurance group is associated with a set of trim parameters for data storage using the set of memory cells. The configuration component 535 may be configured as or otherwise support a means for configuring, in accordance with the set of trim parameters for the endurance group, the set of memory cells and a namespace associated with the set of memory cells, where the namespace corresponds to a range of addresses that includes the set of memory cells in the memory array.

In some examples, the determination component 530 may be configured as or otherwise support a means for determining, based at least in part on the capacity identifier, a second endurance group for a second set of memory cells in the memory array, where the second endurance group is associated with a second set of trim parameters for data storage using the second set of memory cells. In some examples, the configuration component 535 may be configured as or otherwise support a means for configuring, in accordance with the second set of trim parameters for the second endurance group, the second set of memory cells and a second namespace associated with the second set of memory cells, where the second namespace corresponds to a second range of addresses that includes the second set of memory cells in the memory array.

In some examples, the maintenance component 545 may be configured as or otherwise support a means for performing a maintenance procedure for the set of memory cells associated with the endurance group based at least in part on one or more conditions for performing the maintenance procedure for the set of memory cells, where the memory array includes the set of memory cells associated with the endurance group and a second set of memory cells associated with a second endurance group. In some examples, the maintenance component 545 may be configured as or otherwise support a means for refraining from concurrently performing the maintenance procedure for the second set of memory cells associated with the second endurance group based at least in part on performing the maintenance procedure for the endurance group.

In some examples, the reception component 525 may be configured as or otherwise support a means for receiving, from a host device, signaling that indicates a movement of data from the namespace to a second namespace of a plurality of namespaces associated with the memory array. In some examples, the transfer component 540 may be configured as or otherwise support a means for transferring, based at least in part on the signaling, the data from the range of addresses associated with the namespace to a second range of addresses within the memory array that is associated with the second namespace.

In some examples, the movement of the data from the namespace to the second namespace is performed internally by the memory system.

In some examples, the movement of the data from the namespace to the second namespace is based at least in part on how frequently the data is accessed by the host device.

In some examples, the reception component 525 may be configured as or otherwise support a means for receiving a second indication of a second capacity identifier for the memory array. In some examples, the erasure component 550 may be configured as or otherwise support a means for erasing data from the namespace based at least in part on the indication of the second capacity identifier for the memory array. In some examples, the determination component 530 may be configured as or otherwise support a means for determining, based at least in part on the second capacity identifier, a third endurance group for the set of memory cells, where the third endurance group is associated with a third set of trim parameters for data storage using the set of memory cells. In some examples, the configuration component 535 may be configured as or otherwise support a means for configuring, in accordance with the third set of trim parameters for the third endurance group, the set of memory cells and a third namespace associated with the set of memory cells, where the third namespace corresponds to the range of addresses that includes the set of memory cells in the memory array.

In some examples, the capacity identifier is mapped to one or more endurance groups associated with one or more sets of memory cells in the memory array, the one or more endurance groups including at least the endurance group.

In some examples, each endurance group of the one or more endurance groups is associated with a respective set of memory cells from among the one or more sets of memory cells in the memory array and is associated with a respective set of trim parameters for data storage using the respective set of memory cells.

In some examples, a size of the respective set of memory cells associated with each endurance group is based at least in part on the capacity identifier. In some examples, the respective set of trim parameters associated with each endurance group is based at least in part on the capacity identifier.

In some examples, the respective set of memory cells associated with each endurance group includes one or more single-level cells, one or more multi-level cells, one or more triple-level cells, one or more quad-level cells, or one or more penta-level cells based at least in part on the set of trim parameters associated with the respective endurance group.

In some examples, the configuration component 535 may be configured as or otherwise support a means for configuring a plurality of memory cells of a memory device within the memory system to include a first set of memory cells associated with a first endurance group and a second set of memory cells associated with a second endurance group, where the first endurance group is associated with a first set of trim parameters for data storage and the second endurance group is associated with a second set of trim parameters for data storage. In some examples, the reception component 525 may be configured as or otherwise support a means for receiving, from a host device, signaling that indicates a movement of data from a first namespace within the memory device to a second namespace within the memory device, where the first namespace includes a range of addresses associated with the first set of memory cells configured to store the data according to the first set of trim parameters associated with the first endurance group, and where the second namespace includes a second range of addresses associated with the second set of memory cells configured to store the data according to the second set of trim parameters associated with the second endurance group. The transfer component 540 may be configured as or otherwise support a means for transferring, within the memory device, the data from the first set of memory cells to the second set of memory cells based at least in part on the signaling.

In some examples, the first endurance group and the second endurance group are each associated with one or more of a single-level cell configuration, a multi-level cell configuration, a triple-level cell configuration, a quad-level cell configuration, or a penta-level cell configuration based at least in part on the first set of trim parameters and the second set of trim parameters, respectively.

In some examples, the movement of the data from the first namespace to the second namespace is based at least in part on how frequently the data is accessed by the host device.

In some examples, the reception component 525 may be configured as or otherwise support a means for receiving an indication of a capacity identifier for the memory device, where the capacity identifier is associated with the first endurance group and the second endurance group, and where configuring the plurality of memory cells to include the first set of memory cells associated with the first endurance group and the second set of memory cells associated with the second endurance group is based at least in part on the capacity identifier.

In some examples, a size of the first set of memory cells and a size of the second set of memory cells are based at least in part on the capacity identifier. In some examples, the first set of trim parameters and the second set of trim parameters are based at least in part on the capacity identifier.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

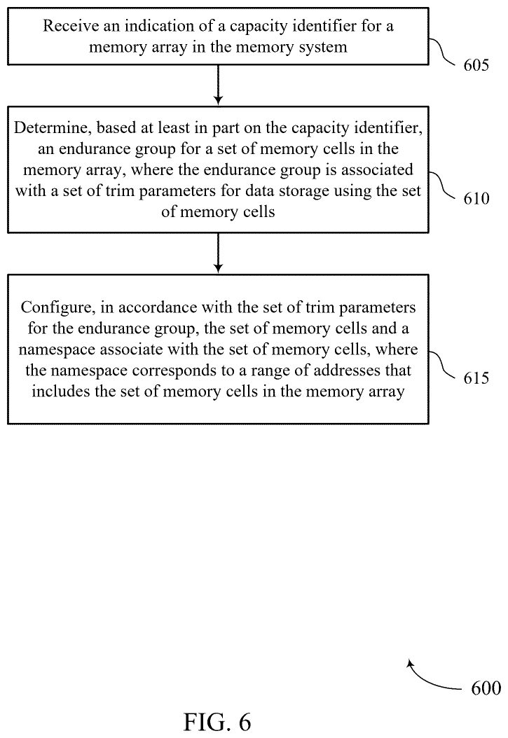

FIG. 6 shows a flowchart illustrating a method 600 that supports endurance group for tiered storage applications in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include receiving an indication of a capacity identifier for a memory array in the memory system. In some examples, aspects of the operations of 605 may be performed by a reception component 525 as described with reference to FIG. 5.

At 610, the method may include determining, based at least in part on the capacity identifier, an endurance group for a set of memory cells in the memory array, where the endurance group is associated with a set of trim parameters for data storage using the set of memory cells. In some examples, aspects of the operations of 610 may be performed by a determination component 530 as described with reference to FIG. 5.

At 615, the method may include configuring, in accordance with the set of trim parameters for the endurance group, the set of memory cells and a namespace associated with the set of memory cells, where the namespace corresponds to a range of addresses that includes the set of memory cells in the memory array. In some examples, aspects of the operations of 615 may be performed by a configuration component 535 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving an indication of a capacity identifier for a memory array in the memory system; determining, based at least in part on the capacity identifier, an endurance group for a set of memory cells in the memory array, where the endurance group is associated with a set of trim parameters for data storage using the set of memory cells; and configuring, in accordance with the set of trim parameters for the endurance group, the set of memory cells and a namespace associated with the set of memory cells, where the namespace corresponds to a range of addresses that includes the set of memory cells in the memory array.

Aspect 2: The method, apparatus, or non-transitory computer-readable medium of aspect 1, further including operations, features, circuitry, logic, means, or instructions, or any combination thereof for determining, based at least in part on the capacity identifier, a second endurance group for a second set of memory cells in the memory array, where the second endurance group is associated with a second set of trim parameters for data storage using the second set of memory cells and configuring, in accordance with the second set of trim parameters for the second endurance group, the second set of memory cells and a second namespace associated with the second set of memory cells, where the second namespace corresponds to a second range of addresses that includes the second set of memory cells in the memory array.

Aspect 3: The method, apparatus, or non-transitory computer-readable medium of any of aspects 1 through 2, further including operations, features, circuitry, logic, means, or instructions, or any combination thereof for performing a maintenance procedure for the set of memory cells associated with the endurance group based at least in part on one or more conditions for performing the maintenance procedure for the set of memory cells, where the memory array includes the set of memory cells associated with the endurance group and a second set of memory cells associated with a second endurance group and refraining from concurrently performing the maintenance procedure for the second set of memory cells associated with the second endurance group based at least in part on performing the maintenance procedure for the endurance group.

Aspect 4: The method, apparatus, or non-transitory computer-readable medium of any of aspects 1 through 3, further including operations, features, circuitry, logic, means, or instructions, or any combination thereof for receiving, from a host device, signaling that indicates a movement of data from the namespace to a second namespace of a plurality of namespaces associated with the memory array and transferring, based at least in part on the signaling, the data from the range of addresses associated with the namespace to a second range of addresses within the memory array that is associated with the second namespace.

Aspect 5: The method, apparatus, or non-transitory computer-readable medium of aspect 4, where the movement of the data from the namespace to the second namespace is performed internally by the memory system.

Aspect 6: The method, apparatus, or non-transitory computer-readable medium of any of aspects 4 through 5, where the movement of the data from the namespace to the second namespace is based at least in part on how frequently the data is accessed by the host device.

Aspect 7: The method, apparatus, or non-transitory computer-readable medium of any of aspects 1 through 6, further including operations, features, circuitry, logic, means, or instructions, or any combination thereof for receiving a second indication of a second capacity identifier for the memory array; erasing data from the namespace based at least in part on the indication of the second capacity identifier for the memory array; determining, based at least in part on the second capacity identifier, a third endurance group for the set of memory cells, where the third endurance group is associated with a third set of trim parameters for data storage using the set of memory cells; and configuring, in accordance with the third set of trim parameters for the third endurance group, the set of memory cells and a third namespace associated with the set of memory cells, where the third namespace corresponds to the range of addresses that includes the set of memory cells in the memory array.

Aspect 8: The method, apparatus, or non-transitory computer-readable medium of any of aspects 1 through 7, where the capacity identifier is mapped to one or more endurance groups associated with one or more sets of memory cells in the memory array, the one or more endurance groups including at least the endurance group.

Aspect 9: The method, apparatus, or non-transitory computer-readable medium of aspect 8, where each endurance group of the one or more endurance groups is associated with a respective set of memory cells from among the one or more sets of memory cells in the memory array and is associated with a respective set of trim parameters for data storage using the respective set of memory cells.

Aspect 10: The method, apparatus, or non-transitory computer-readable medium of aspect 9, where a size of the respective set of memory cells associated with each endurance group is based at least in part on the capacity identifier and the respective set of trim parameters associated with each endurance group is based at least in part on the capacity identifier.

Aspect 11: The method, apparatus, or non-transitory computer-readable medium of any of aspects 8 through 10, where the respective set of memory cells associated with each endurance group includes one or more multi-level cells, one or more single-level cells, one or more triple-level cells, one or more quad-level cells, or one or more penta-level cells based at least in part on the set of trim parameters associated with the respective endurance group.

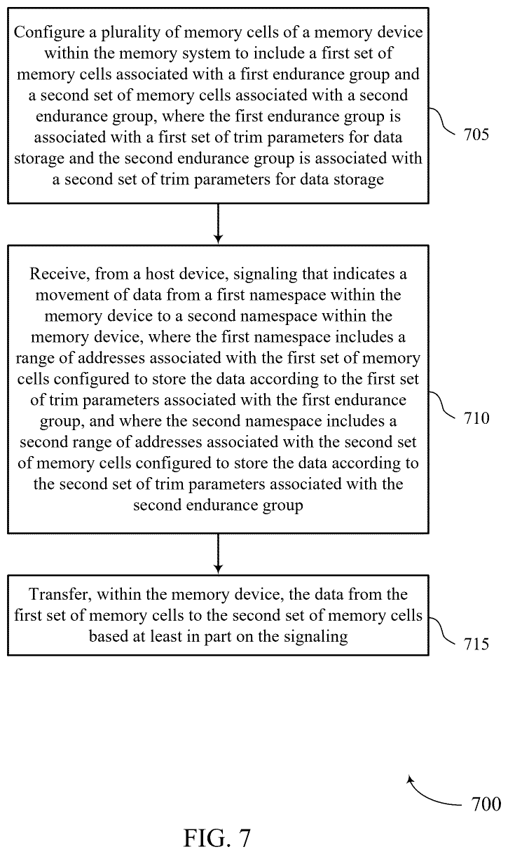

FIG. 7 shows a flowchart illustrating a method 700 that supports endurance group for tiered storage applications in accordance with examples as disclosed herein. The operations of method 700 may be implemented by a memory system or its components as described herein. For example, the operations of method 700 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 705, the method may include configuring a plurality of memory cells of a memory device within the memory system to include a first set of memory cells associated with a first endurance group and a second set of memory cells associated with a second endurance group, where the first endurance group is associated with a first set of trim parameters for data storage and the second endurance group is associated with a second set of trim parameters for data storage. In some examples, aspects of the operations of 705 may be performed by a configuration component 535 as described with reference to FIG. 5.

At 710, the method may include receiving, from a host device, signaling that indicates a movement of data from a first namespace within the memory device to a second namespace within the memory device, where the first namespace includes a range of addresses associated with the first set of memory cells configured to store the data according to the first set of trim parameters associated with the first endurance group, and where the second namespace includes a second range of addresses associated with the second set of memory cells configured to store the data according to the second set of trim parameters associated with the second endurance group. In some examples, aspects of the operations of 710 may be performed by a reception component 525 as described with reference to FIG. 5.

At 715, the method may include transferring, within the memory device, the data from the first set of memory cells to the second set of memory cells based at least in part on the signaling. In some examples, aspects of the operations of 715 may be performed by a transfer component 540 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 12: A method, apparatus, or non-transitory computer-readable medium including operations, features, circuitry, logic, means, or instructions, or any combination thereof for configuring a plurality of memory cells of a memory device within the memory system to include a first set of memory cells associated with a first endurance group and a second set of memory cells associated with a second endurance group, where the first endurance group is associated with a first set of trim parameters for data storage and the second endurance group is associated with a second set of trim parameters for data storage; receiving, from a host device, signaling that indicates a movement of data from a first namespace within the memory device to a second namespace within the memory device, where the first namespace includes a range of addresses associated with the first set of memory cells configured to store the data according to the first set of trim parameters associated with the first endurance group, and where the second namespace includes a second range of addresses associated with the second set of memory cells configured to store the data according to the second set of trim parameters associated with the second endurance group; and transferring, within the memory device, the data from the first set of memory cells to the second set of memory cells based at least in part on the signaling.

Aspect 13: The method, apparatus, or non-transitory computer-readable medium of aspect 12, where the first endurance group and the second endurance group are each associated with one or more of a single-level cell configuration, a triple-level cell configuration, or a quad-level cell configuration based at least in part on the first set of trim parameters and the second set of trim parameters, respectively.

Aspect 14: The method, apparatus, or non-transitory computer-readable medium of any of aspects 12 through 13, where the movement of the data from the first namespace to the second namespace is based at least in part on how frequently the data is accessed by the host device.

Aspect 15: The method, apparatus, or non-transitory computer-readable medium of any of aspects 12 through 14, further including operations, features, circuitry, logic, means, or instructions, or any combination thereof for receiving an indication of a capacity identifier for the memory device, where the capacity identifier is associated with the first endurance group and the second endurance group, and where configuring the plurality of memory cells to include the first set of memory cells associated with the first endurance group and the second set of memory cells associated with the second endurance group is based at least in part on the capacity identifier.

Aspect 16: The method, apparatus, or non-transitory computer-readable medium of aspect 15, where a size of the first set of memory cells and a size of the second set of memory cells are based at least in part on the capacity identifier and the first set of trim parameters and the second set of trim parameters are based at least in part on the capacity identifier.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 17: A memory system, including: one or more memory dies, where each memory die of the one or more memory dies includes: a memory array including a plurality of memory cells; a first set of memory cells from among the plurality of memory cells in the memory array, the first set of memory cells associated with a first endurance group, where the first endurance group is associated with a first set of trim parameters for data storage using the first set of memory cells; and a second set of memory cells from among the plurality of memory cells in the memory array, the second set of memory cells associated with a second endurance group, where the second endurance group is associated with a second set of trim parameters for data storage using the second set of memory cells; and one or more controllers coupled with the one or more memory dies and configured to: configure the plurality of memory cells in the memory array to include the first set of memory cells associated with the first set of trim parameters and the second set of memory cells associated with the second set of trim parameters based at least in part on a capacity identifier that indicates the first endurance group and the second endurance group.

Aspect 18: The memory system of aspect 17, where: the first set of memory cells are associated with a first namespace including a first range of addresses within the memory array that includes the first set of memory cells; and the second set of memory cells are associated with a second namespace including a second range of addresses within the memory array that includes the second set of memory cells.

Aspect 19: The memory system of aspect 18, where the one or more controllers are further configured to: receive, from a host device, signaling that requests movement of data from the first namespace to the second namespace; and transfer the data from the first set of memory cells to the second set of memory cells based at least in part on the signaling.

Aspect 20: The memory system of any of aspects 17 through 19, where: the first set of memory cells are associated with a first namespace and a second namespace; the first namespace includes a first range of addresses within the memory array that includes a first subset of memory cells from among the first set of memory cells; and the second namespace includes a second range of addresses within the memory array that includes a second subset of memory cells from among the first set of memory cells.

Aspect 21: The memory system of aspect 20, where the one or more controllers are further configured to: receive, from a host device, signaling that requests movement of data from the first namespace to the second namespace; and transfer the data from the first subset of memory cells to the second subset of memory cells based at least in part on the signaling.

Aspect 22: The memory system of any of aspects 17 through 21, where the first endurance group and the second endurance group are each associated with one or more of a single-level cell configuration, a multi-level cell configuration, a triple-level cell configuration, a quad-level cell configuration, or a penta-level cell configuration based at least in part on the first set of trim parameters and the second set of trim parameters, respectively.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive an indication of a capacity identifier for a memory array in the memory system;
determine, based at least in part on the capacity identifier, an endurance group for a set of memory cells in the memory array, wherein the endurance group is associated with a set of trim parameters for data storage using the set of memory cells; and
configuring, in accordance with the set of trim parameters for the endurance group, the set of memory cells and a namespace associate with the set of memory cells, wherein the namespace corresponds to a range of addresses that includes the set of memory cells in the memory array.

2. The memory system of claim 1, wherein the processing circuitry is further configured to cause the memory system to:
determine, based at least in part on the capacity identifier, a second endurance group for a second set of memory cells in the memory array, wherein the second endurance group is associated with a second set of trim parameters for data storage using the second set of memory cells; and
configuring, in accordance with the second set of trim parameters for the second endurance group, the second set of memory cells and a second namespace associate with the second set of memory cells, wherein the second namespace corresponds to a second range of addresses that includes the second set of memory cells in the memory array.

3. The memory system of claim 1, wherein the processing circuitry is further configured to cause the memory system to:
perform a maintenance procedure for the set of memory cells associated with the endurance group based at least in part on one or more conditions for performing the maintenance procedure for the set of memory cells, wherein the memory array comprises the set of memory cells associated with the endurance group and a second set of memory cells associated with a second endurance group; and
refrain from concurrently performing the maintenance procedure for the second set of memory cells associated with the second endurance group based at least in part on performing the maintenance procedure for the endurance group.

4. The memory system of claim 1, wherein the processing circuitry is further configured to cause the memory system to:
receive, from a host device, signaling that indicates a movement of data from the namespace to a second namespace of a plurality of namespaces associated with the memory array; and
transfer, based at least in part on the signaling, the data from the range of addresses associated with the namespace to a second range of addresses within the memory array that is associated with the second namespace.

5. The memory system of claim 4, wherein the movement of the data from the namespace to the second namespace is performed internally by the memory system.

6. The memory system of claim 4, wherein the movement of the data from the namespace to the second namespace is based at least in part on how frequently the data is accessed by the host device.

7. The memory system of claim 1, wherein the processing circuitry is further configured to cause the memory system to:
receive a second indication of a second capacity identifier for the memory array;
erase data from the namespace based at least in part on the indication of the second capacity identifier for the memory array;
determine, based at least in part on the second capacity identifier, a third endurance group for the set of memory cells, wherein the third endurance group is associated with a third set of trim parameters for data storage using the set of memory cells; and
configuring, in accordance with the third set of trim parameters for the third endurance group, the set of memory cells and a third namespace associate with the set of memory cells, wherein the third namespace corresponds to the range of addresses that includes the set of memory cells in the memory array.

8. The memory system of claim 1, wherein the capacity identifier is mapped to one or more endurance groups associated with one or more sets of memory cells in the memory array, the one or more endurance groups comprising at least the endurance group.

9. The memory system of claim 8, wherein each endurance group of the one or more endurance groups is associated with a respective set of memory cells from among the one or more sets of memory cells in the memory array and is associated with a respective set of trim parameters for data storage using the respective set of memory cells.

10. The memory system of claim 9, wherein:
a size of the respective set of memory cells associated with each endurance group is based at least in part on the capacity identifier; and
the respective set of trim parameters associated with each endurance group is based at least in part on the capacity identifier.

11. The memory system of claim 9, wherein the respective set of memory cells associated with each endurance group comprises one or more single-level cells, one or more multi-level cells, one or more triple-level cells, one or more quad-level cells, or one or more penta-level cells based at least in part on the set of trim parameters associated with the respective endurance group.

12. A memory system, comprising:
one or more memory dies, wherein each memory die of the one or more memory dies comprises:
a memory array comprising a plurality of memory cells;
a first set of memory cells from among the plurality of memory cells in the memory array, the first set of memory cells associated with a first endurance group, wherein the first endurance group is associated with a first set of trim parameters for data storage using the first set of memory cells;
a second set of memory cells from among the plurality of memory cells in the memory array, the second set of memory cells associated with a second endurance group, wherein the second endurance group is associated with a second set of trim parameters for data storage using the second set of memory cells; and
one or more controllers coupled with the one or more memory dies and configured to:
configure the plurality of memory cells in the memory array to include the first set of memory cells associated with the first set of trim parameters and the second set of memory cells associated with the second set of trim parameters based at least in part on a capacity identifier that indicates the first endurance group and the second endurance group.

13. The memory system of claim 12, wherein:
the first set of memory cells are associated with a first namespace comprising a first range of addresses within the memory array that includes the first set of memory cells; and
the second set of memory cells are associated with a second namespace comprising a second range of addresses within the memory array that includes the second set of memory cells.

14. The memory system of claim 13, wherein the one or more controllers are further configured to:
receive, from a host device, signaling that requests movement of data from the first namespace to the second namespace; and
transfer the data from the first set of memory cells to the second set of memory cells based at least in part on the signaling.

15. The memory system of claim 12, wherein:
the first set of memory cells are associated with a first namespace and a second namespace;
the first namespace comprises a first range of addresses within the memory array that includes a first subset of memory cells from among the first set of memory cells; and
the second namespace comprises a second range of addresses within the memory array that includes a second subset of memory cells from among the first set of memory cells.

16. The memory system of claim 15, wherein the one or more controllers are further configured to:
receive, from a host device, signaling that requests movement of data from the first namespace to the second namespace; and
transfer the data from the first subset of memory cells to the second subset of memory cells based at least in part on the signaling.

17. The memory system of claim 12, wherein the first endurance group and the second endurance group are each associated with one or more of a single-level cell configuration, a multi-level cell configuration, a triple-level cell configuration, a quad-level cell configuration, or a penta-level cell configuration based at least in part on the first set of trim parameters and the second set of trim parameters, respectively.

18. A memory system, comprising:
one or more memory devices; and
processing circuitry coupled with the one or more memory devices and configured to cause the memory system to:
configure a plurality of memory cells of a memory device within the memory system to include a first set of memory cells associated with a first endurance group and a second set of memory cells associated with a second endurance group, wherein the first endurance group is associated with a first set of trim parameters for data storage and the second endurance group is associated with a second set of trim parameters for data storage;
receive, from a host device, signaling that indicates a movement of data from a first namespace within the memory device to a second namespace within the memory device, wherein the first namespace comprises a range of addresses associated with the first set of memory cells configured to store the data according to the first set of trim parameters associated with the first endurance group, and wherein the second namespace comprises a second range of addresses associated with the second set of memory cells configured to store the data according to the second set of trim parameters associated with the second endurance group; and
transfer, within the memory device, the data from the first set of memory cells to the second set of memory cells based at least in part on the signaling.

19. The memory system of claim 18, wherein the first endurance group and the second endurance group are each associated with one or more of a single-level cell configuration, a multi-level cell configuration, a triple-level cell configuration, a quad-level cell configuration, or a penta-level cell configuration based at least in part on the first set of trim parameters and the second set of trim parameters, respectively.

20. The memory system of claim 18, wherein the movement of the data from the first namespace to the second namespace is based at least in part on how frequently the data is accessed by the host device.

21. The memory system of claim 18, wherein the processing circuitry is further configured to cause the memory system to:
receive an indication of a capacity identifier for the memory device, wherein the capacity identifier is associated with the first endurance group and the second endurance group, and wherein configuring the plurality of memory cells to include the first set of memory cells associated with the first endurance group and the second set of memory cells associated with the second endurance group is based at least in part on the capacity identifier.

22. The memory system of claim 21, wherein:
a size of the first set of memory cells and a size of the second set of memory cells are based at least in part on the capacity identifier; and
the first set of trim parameters and the second set of trim parameters are based at least in part on the capacity identifier.

23. A method by a memory system, comprising:
configuring a plurality of memory cells of a memory device within the memory system to include a first set of memory cells associated with a first endurance group and a second set of memory cells associated with a second endurance group, wherein the first endurance group is associated with a first set of trim parameters for data storage and the second endurance group is associated with a second set of trim parameters for data storage;
receiving, from a host device, signaling that indicates a movement of data from a first namespace within the memory device to a second namespace within the memory device, wherein the first namespace comprises a range of addresses associated with the first set of memory cells configured to store the data according to the first set of trim parameters associated with the first endurance group, and wherein the second namespace comprises a second range of addresses associated with the second set of memory cells configured to store the data according to the second set of trim parameters associated with the second endurance group; and
transferring, within the memory device, the data from the first set of memory cells to the second set of memory cells based at least in part on the signaling.

24. The method of claim 23, wherein the movement of the data from the first namespace to the second namespace is based at least in part on how frequently the data is accessed by the host device.

25. The method of claim 23, further comprising:
receiving an indication of a capacity identifier for the memory device, wherein the capacity identifier is associated with the first endurance group and the second endurance group, and wherein configuring the plurality of memory cells to include the first set of memory cells associated with the first endurance group and the second set of memory cells associated with the second endurance group is based at least in part on the capacity identifier.

26. A method by a memory system, comprising:
receiving an indication of a capacity identifier for a memory array in the memory system;
determining, based at least in part on the capacity identifier, an endurance group for a set of memory cells in the memory array, wherein the endurance group is associated with a set of trim parameters for data storage using the set of memory cells; and
configuring, in accordance with the set of trim parameters for the endurance group, the set of memory cells and a namespace associated with the set of memory cells, wherein the namespace corresponds to a range of addresses that includes the set of memory cells in the memory array.

27. The method of claim 26, further comprising:
determining, based at least in part on the capacity identifier, a second endurance group for a second set of memory cells in the memory array, wherein the second endurance group is associated with a second set of trim parameters for data storage using the second set of memory cells; and
configuring, in accordance with the second set of trim parameters for the second endurance group, the second set of memory cells and a second namespace associated with the second set of memory cells, wherein the second namespace corresponds to a second range of addresses that includes the second set of memory cells in the memory array.

28. The method of claim 26, further comprising:
performing a maintenance procedure for the set of memory cells associated with the endurance group based at least in part on one or more conditions for performing the maintenance procedure for the set of memory cells, wherein the memory array comprises the set of memory cells associated with the endurance group and a second set of memory cells associated with a second endurance group; and
refraining from concurrently performing the maintenance procedure for the second set of memory cells associated with the second endurance group based at least in part on performing the maintenance procedure for the endurance group.

29. The method of claim 26, further comprising:
receiving, from a host device, signaling that indicates a movement of data from the namespace to a second namespace of a plurality of namespaces associated with the memory array; and
transferring, based at least in part on the signaling, the data from the range of addresses associated with the namespace to a second range of addresses within the memory array that is associated with the second namespace.

30. The method of claim 26, further comprising:
receiving a second indication of a second capacity identifier for the memory array;
erasing data from the namespace based at least in part on the indication of the second capacity identifier for the memory array;
determining, based at least in part on the second capacity identifier, a third endurance group for the set of memory cells, wherein the third endurance group is associated with a third set of trim parameters for data storage using the set of memory cells; and
configuring, in accordance with the third set of trim parameters for the third endurance group, the set of memory cells and a third namespace associated with the set of memory cells, wherein the third namespace corresponds to the range of addresses that includes the set of memory cells in the memory array.
